(19) United States
(12) Patent Application Publication
(10) Pub. No.: US 2023/0328050 A1
(43) Pub. Date: Oct. 12, 2023

(54) USING AUTHENTICATION CREDENTIALS TO VALIDATE BLOCKCHAIN ADDITIONS

(71) Applicant: MICRO FOCUS LLC, Santa Clara, CA (US)

(72) Inventors: Douglas Max Grover, Rigby, ID (US); Michael F. Angelo, Houston, TX (US)

(73) Assignee: MICRO FOCUS LLC, Santa Clara, CA (US)

(21) Appl. No.: 17/716,763

(22) Filed: Apr. 8, 2022

(51) Int. Cl. H04L 9/40

(52) U.S. Cl. CPC H04L 63/0428; H04L 63/0838

(57) ABSTRACT

A request is received, by a plurality of nodes that are part of a distributed blockchain ledger, to add a transaction block to a plurality of blockchains in the distributed blockchain ledger. The transaction block comprises a transaction block authentication credential(s). The plurality of nodes that are part of the distributed blockchain ledger determine if the transaction block authentication credential(s) are valid. An indication is received from at least a majority of the plurality of nodes that are part of the distributed blockchain ledger that the transaction block authentication credential(s) are valid. In response to receiving the indication from the at least a majority of the plurality of nodes that are part of the distributed blockchain ledger that the transaction block authentication credential(s) are valid, the transaction block is added to the plurality of blockchains in the distributed blockchain ledger.

### FIELD

The disclosure relates generally to blockchains and particularly to blockchain security.

### BACKGROUND

One of the key advantages of a blockchain is that the data is highly immutable. However, if a user's credential for adding blocks to the blockchain has become compromised, the immutability of the blockchain becomes irrelevant. New blocks can be added to the blockchain using the compromised credential; thus, even though the blockchain itself is highly immutable, the transaction data captured in the newly added block is compromised.

### SUMMARY

These and other needs are addressed by the various embodiments and configurations of the present disclosure. The present disclosure can provide a number of advantages depending on the particular configuration. These and other advantages will be apparent from the disclosure contained herein.

A request is received, by a plurality of nodes that are part of a distributed blockchain ledger, to add a transaction block to a plurality of blockchains in the distributed blockchain ledger. The transaction block comprises a transaction block authentication credential(s). The plurality of nodes that are part of the distributed blockchain ledger determine if the transaction block authentication credential(s) are valid. An indication is received from at least a majority of the plurality of nodes that are part of the distributed blockchain ledger that the transaction block authentication credential(s) are valid. In response to receiving the indication from the at least a majority of the plurality of nodes that are part of the distributed blockchain ledger that the transaction block authentication credential(s) are valid, the transaction block is added to the plurality of blockchains in the distributed blockchain ledger.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed blockchain ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for using authentication credentials to validate transaction block additions to a blockchain.

FIG. 2 is a diagram of an exemplary blockchain.

FIG. 3 is a flow diagram of a process for using authentication credentials to validate transaction block additions to a blockchain.

FIG. 4 is a flow diagram of a process for generating codes to validate transaction block additions to a blockchain.

FIG. 5 is a flow diagram of a process for determining that a user has authenticated properly and for generating/adding authentication credentials to a transaction block.

FIG. 6 is a flow diagram of a process for providing authentication credentials to a distributed blockchain ledger.

FIG. 7 is a flow diagram of a process for managing authentication credentials in a distributed ledger.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

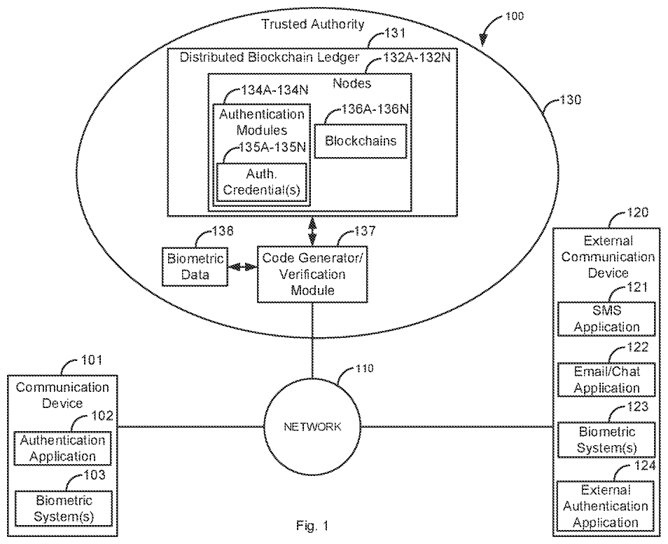

FIG. 1 is a block diagram of a first illustrative system 100 for using authentication credentials 135 to validate transaction block 202 additions to a blockchain 136. The first illustrative system 100 comprises a communication device 101, a network 110, an external communication device 120, and a trusted authority 130.

The communication device 101 can be or may include any device that can communicate on the network 110, such as a Personal Computer (PC), a telephone, a video system, a cellular telephone, a Personal Digital Assistant (PDA), a tablet device, a notebook device, a smartphone, a server, and/or the like. Although FIG. 1 only shows a single communication deice 101 for simplicity, any number of communication devices 101 may be connected to the network 110.

The communication device 101 comprises an authentication application 102 and biometric system(s) 103. The authentication application 102 can be any hardware coupled with software that helps to authenticate a user with the trusted authority 130. The authentication application 102 may support various authentication techniques, such as, usernames/passwords, security questions, biometric(s), security ID cards, and/or the like.

The biometric system(s) 103 are hardware coupled with software that take biometric scans, such as, fingerprint scans, palm scans, iris scans, facial scans, voiceprints, and/or the like. The biometric system(s) 103 may comprise systems that can capture multiple biometrics. For example, the biometric system(s) 103 may comprise a fingerprint scanner and a voiceprint device/system. The biometric systems 103 may include input devices, such as a camera, a touch screen, a sensor array, a microphone, a keyboard, and/or the like.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and/or the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The external communication device 120 is typically a second device that is owned or accessed by the user. For example, the communication device 101 may be the user's laptop computer and the external communication device 120 may be the user's smartphone. The external communication device 120 may be similar to the communication device 101. The external communication device 120 is typically used as part of a multi-factor authentication process. For example, the user will provide a username/password at the communication device 101 and receive a Short Message Service (SMS) code via the external communication device 120. The user will then provide the SMS code as the second authentication factor to validate a transaction using the external authentication application 124.

The external communication device 120 comprises an SMS application 121, an email/chat application 122, biometric system(s) 123, and an external authentication application 124. The SMS application 121 may be any SMS or SMS like application where a text message may be sent to and typically displayed/captured via the external communication device 120. The text message includes a code (an authentication credential 235). The user typically provides the SMS code as part of the multi-factor authentication process. In one embodiment, the user is asked to approve receipt of the SMS code via the external authentication application 124 instead of copying the SMS code from the SMS application 121 to the external authentication application 124.

The email/chat application 122 may be any known or existing email application, such as Microsoft Outlook™, Microsoft Teams™, Google Mail™, Micro Focus Groupwise™, and/or the like. The email/chat application 122 is used to access a code (an authentication credential 235) that the user provides as part of the multi-factor authentication process. For example, the user may copy the code from an email in the email/chat application 122 into the external authentication application 124 as part of the authentication process.

The biometric system(s) 123 may be similar and/or different from the biometric system(s) 103. For example, the biometric system(s) 103 may provide a voiceprint and the biometric system 123 may be used to provide a fingerprint and/or iris scan as part of a multi-factor authentication process.

The external authentication application 124 can be or may include any hardware coupled with software that can be used to manage the receipt of authentication codes (authentication credentials 235). The external authentication application 124 can confirm receipt of an authentication code. The external authentication application 124 may be used to copy an authentication code, and/or the like. For example, the external authentication application 124 may be used to receive a copy of an SMS code, an email code, a chat code, and/or the like to send back to the trusted authority 130 as part of an authentication process.

The trusted authority 130 can be or may include any entity, service, process, and/or the like that can be used to provide trusted services. The trusted authority 130 may be a third-party service, an internal service, and/or the like. The trusted services may include encryption services, digital certificate management, authentication services, security services, transaction validation services, and/or the like. The trusted authority 130 comprises a distributed blockchain ledger 131, a code generator/verification module 137, and biometric data 138.

The distributed blockchain ledger 131 comprises nodes 132A-132N. The distributed blockchain ledger 131 is where there are a plurality of nodes 132A-132N that replicate a blockchain 136A-136N in the distributed blockchain ledger 131 to provide immutability of transactions. The blockchains 136A-136N may be created using known blockchain structures in conjunction with the processes described herein. New transaction blocks 202 are added to the blockchains 136A-136N based on a consensus vote of the nodes 132A-132N/authentication modules 134A-134N.

The nodes 132A-132N further comprise authentication modules 134A-134N and the blockchains 136A-136N. The authentication modules 134A-134N are used to authenticate the addition of transaction blocks 202 to the blockchains 136A-136N. The authentication modules 134A-134N authenticate the addition of the transaction blocks 202 to the blockchains 136A-136N based on the authentication credentials 135A-135N.

The authentication credentials 135A-135N, as described herein and in the claims, can be any type of authentication credential, such as, a signed credential, an SMS code, an email code, a chat code, a hash, and/or the like. The authentication credentials 135A-135N are uniquely tied to a user and an authentication factor. The authentication factors for the authentication credentials 135A-135N may be for biometric(s), username/password(s), security questions, security ID cards, SMD/email/chat codes, and/or the like.

The code generator/verification module 137 can be or may include any hardware coupled with software that can be used to validate the authentication process and generate authentication credentials 135A-135N. The code generator/verification module 137 can be used to compare the biometric data 138 to biometric data 138 received from the biometric system(s) 103/123 as part of the authentication process.

The biometric data 138 may comprise any type of biometric data 138, such as, fingerprint data, palm print data, facial print data, iris print data, voiceprint data, and/or the like. The biometric data 138 may be initially generated by the biometric system(s) 103/123 as part of a registration process that registers a user's biometric data 138. The biometric data 138 may be stored using known structures/techniques. The biometric data 138 may also accommodate new types of biometric data 138. The biometric data 138 may also include non-biometric data, such as, a username/password, security questions, security ID card information, and/or the like.

The first illustrative system 100 allows the user to authenticate a transaction block 202 that is requested to be added to the blockchain 136 based on the authentication credentials 135A-135N that are stored in each of the nodes 132A-132N.

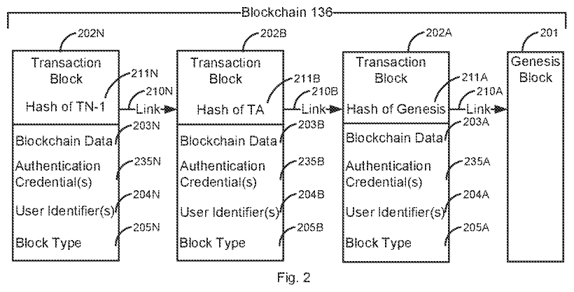

FIG. 2 is a diagram of an exemplary blockchain 136. The blockchain 136 may be any type of blockchain 136, such as, a secure contract blockchain, a digital currency blockchain, an event tracking blockchain, an Internet-of-Things (IoT) blockchain, a financial transaction blockchain, an inventory blockchain, and/or the like. The blockchain 136 shown in FIG. 2 is replicated in each of the nodes 132A-132N in the distributed blockchain ledger 131.

The blockchain 136 comprises a genesis block 201 and transaction blocks 202A-202N. The transaction blocks 202A-202N and the genesis block 201 are linked together by forward links 210A-210N as is traditionally done in blockchains 136. The genesis block 201 is the first block in the blockchain 136.

The transaction blocks 202A-202N further comprise forward hashes 211A-211N, blockchain data 203A-203N, user identifiers 204A-204N, block types 205A-205N, and authentication credentials 235A-235N. The forward hashes 211A-211N are forward hashes of the previous transaction block 202/genesis block 201. For example, the transaction block 202N has a forward hash 211N of the transaction block 202B (assuming that there are no intervening transactions blocks 202). The transaction block 202B has a forward hash 211B of the transaction block 202A. Likewise, the transaction block 202A has a forward hash 211A of the genesis block 201.

As shown in FIG. 2, the transaction blocks 202A-202N have blockchain data 203A-203N. The blockchain data 203A-203N may be any type of data stored in the blockchain 136, such as, user information, financial information, database information, documents, records, files, and/or the like. The blockchain data 203A-203N may be in the blockchain 136 and/or pointed to by the blockchain data 203A-203N. The blockchain data 203A-203N may comprise different fields and/or types of blockchain data 203A-203N.

The user identifier(s) 204A-204N are identifier(s) that identify which user is associated with which authentication credential(s) 235A-235N. In some embodiments, there may be multiple users who must authenticate for a transaction to occur. For example, there may be two authentication credentials 235A in the transaction block 202A that are associated with two different users. The authentication credentials 235 may be associated with the same user but each authentication credential 235 is associated with a specific authentication factor. For example, the authentication credentials 235A may comprise a username/password authentication credential 235A associated with User A and a security question authentication credential 235A also associated with User A.

The block types 205A-205N identify a type of transaction/transaction block 202. The block type 205 is used to determine what authentication factors are required to add a transaction block 202 to the blockchain 136. The block type 205 may be different based on the transaction. For example, for an add user transaction block 202, the block type 205 may require multifactor authentication where the block type 205 of accessing the blockchain data 203 may only require a single authentication factor. In one embodiment, the transaction block(s) 202 may not store the block type 205 in the transaction block 202. Instead, the block type 205 may be based on rules regarding the transactions supported by the blockchain 136. The rules may be defined in the authentication modules 134A-134N.

The authentication credentials 235A-235N are generated and stored in the transaction blocks 202A-202N based the number of authentication factors required to approve the transaction. There may be zero or one or more authentication credentials 235 in each transaction block 202A-202N. The number of authentication credentials 235 in the transaction blocks 202A-202N correlate to the number of authentication factor(s) required by the user(s) to authenticate the transaction of the transaction block 202. The number of authentication credentials 235 in each transaction block 202A-202N may vary based on the block type 205 of the transaction block 202. For example, the transaction for the transaction block 202A may only require a single authentication factor (e.g., a username/password) to approve the transaction. Thus, the transaction block 202A only has a single authentication credential 235A. The transaction block 202B may require two authentication factors (e.g., a username/password and a fingerprint scan). Thus, the transaction block 202B will have two authentication credentials 235B that correlate to the required number of authentication factors to approve the transaction for the transaction block 202B.

To illustrate, consider the following examples. When a user wants to approve/complete a transaction that is stored in the blockchain 136, the user must authenticate using the required number of authentication factor(s) for the specific block type 205. For example, where a single authentication factor is required, the user may have logged in via the trusted authority 130 using a username/password from the communication device 101. Once the username/password is verified, the login process generates an authentication credential 135 for the username/password. For example, a hash of the username/password and a nonce may be generated as the authentication credential 135 or a Hashed-based Message Authentication Code (HMAC) of information with a secret key known to the distributed blockchain ledger 131 (i.e., Hash[Hash[username], nonce]) may be generated as the authentication credential 135. The authentication credential 135 for the username/password is provided to the authentication modules 134A-134N in the distributed blockchain ledger 131. In other words, each of the authentication modules 134A-134N has a copy of the username/password authentication credential 135A-135N. When a new transaction block 202 is to be added, the nodes 132A-132N, via the authentication modules 134A-134N, validate that the user is still logged in or requests the user to login. If the user is logged in, the authentication credential 235 is generated and stored in the new transaction block 202. The copy of the username/password authentication credential 135A-135N is compared against the username/password authentication credential 235 that is in the new transaction block 202. If a consensus of the authentication modules 134A-134N determine that the authentication credential 235 matches the authentication credential 135, the new transaction block 202 is added to the respective blockchains 136A-136N in the distributed blockchain ledger 131.

If the user must provide a second authentication credential 235 to validate the transaction a similar process is used. For example, if the second authentication factor is a fingerprint scan on the external communication device 120 using the biometric system(s) 123, the code generator/verification module 137 receives the fingerprint scan (e.g., the minutia points) from the biometric system(s) 123 and verifies that the fingerprint scan is valid. An authentication credential 235 is generated based on the validated fingerprint scan of the user. Verification of a valid fingerprint may unlock a secret private key to sign a hash of the transaction block 202/timestamp. The transaction block 202 is signed using the private key—e.g., block hash of the blockchain data 203 and a timestamp. The authentication modules 134A-134N verify that the generated authentication credential 235 in the new transaction block 202 is valid by comparing it to the authentication credentials 135A-135N that are stored in the nodes 132A-132N distributed blockchain ledger 131. The distributed blockchain ledger 131 may have authentication credentials 135 for multiple users/private keys.

If the second authentication factor is an SMS code, the SMS code (generated by the code generator/verification module 137) is the provided to the authentication modules 134A-134N in the distributed blockchain ledger 131. The SMS code (authentication credential 235) is then sent to the SMS application 121 in the external communication device 120. The user then copies/approves the SMS code in/to the external authentication application 124. The copied/approved SMS code is sent back to the code generator/verification module 137. The received SMS code is added to the new transaction block 202 by code generator/verification module 137. The authentication modules 134A-134N then validate that the SMS code is valid. If a conscious of the authentication modules 134A-134N determine that the authentication credential 235 (the received SMS code) in the new transaction block 202 is valid, the new transaction block 202 is added to the blockchains 135A-136N in the distributed blockchain ledger 131. Likewise, a similar process can be used for codes sent via an email application/chat application using the email/chat application 122.

The blockchain 136 of FIG. 2 shows where the authentication credential(s) 235A-235N are in each transaction block 202A-202N. However, other embodiments may not have the authentication credentials 235 in each transaction block 202. For example, some transaction types (i.e., specific block types 205) may not require any authentication factors and thus would have no authentication credentials 235 in transaction blocks 202 with that block type 205.

In one embodiment, the authentication credentials 135/235 may be a single use authentication credential 135/235. For example, the authentication credentials 135/235 may only be used once. If the user wants to complete a second transaction, the user will have to authenticate again using the required authentication factors.

Alternatively, the authentication credential(s) 135/235 may apply to several transaction blocks 202. The login credentials in the transaction block 202A may cover a defined number of transactions/transaction blocks 202. For example, the transaction credential(s) 235A in the transaction block 202A may apply to two transaction blocks (i.e., transaction blocks 202A-202B). Thus, the transaction block 202B may not have any authentication credentials 235 (or could have the same authentication credentials 235A in the transaction block 202A). In this embodiment, the transaction block 202A may indicate the number of transactions/transaction blocks 202 that are covered by the authentication credential(s) 235A. If the authentication credential(s) 235 are based on a number of transactions, once the number of transactions has been met, the user will have to re-authenticate so that a new transaction/transaction block 202 can be added to the blockchains 136A-136N in the distributed blockchain ledger 131.

In one embodiment, the authentication credential(s) 235 may only apply when the user is logged in (i.e., for a session). For example, the user may be required to provide a username/password and an email code to complete the initial transaction (e.g., defined in transaction block 202A). While the user is logged in, any new transaction blocks 202 may not have any authentication credentials 235 or the new transaction blocks 202 may have the same authentication credentials 235A as the transaction block 202A (assuming that the block type 205 of each transaction block 202 is the same). If the user logs out, the user must be reauthenticated using the required authentication factors to complete any new transactions that require the authentication credentials 135/235.

If the user has only partially authenticated, the user will be asked to provide the additional authentication factors if the block type 205 requires additional authentication factor(s). For example, if the user has only logged in using a username/password and the block type 205 also requires an iris scan, the user will be asked to provide the iris scan to complete the transaction to add the new transaction block 202.

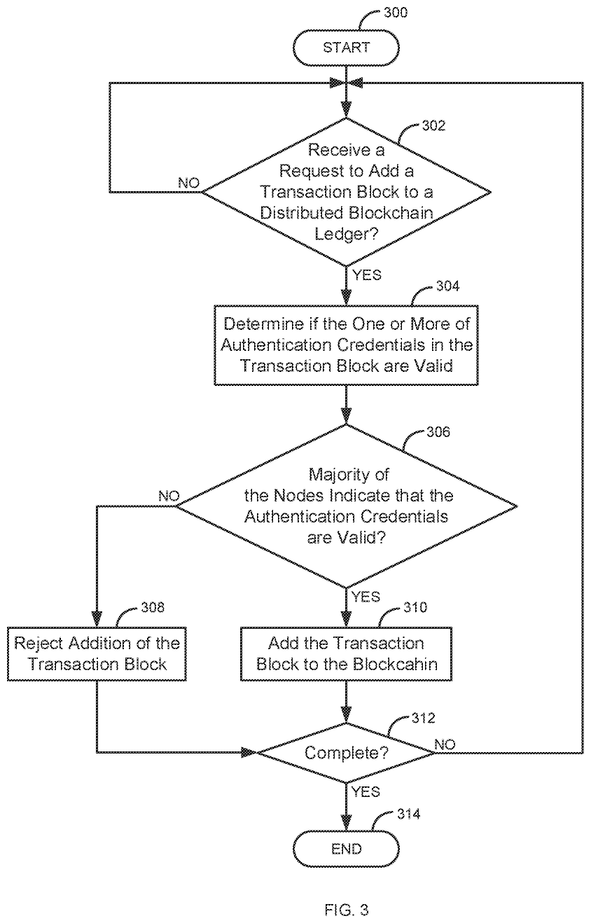

FIG. 3 is a flow diagram of a process for using authentication credentials 135/235 to validate transaction block 202 additions to a blockchain 136. Illustratively, the communication device 101, the authentication application 102, the biometric system(s) 103, the external communication device 120, the SMS application 121, the email/chat application 122, the biometric system(s) 123, the external authentication application 124, the trusted authority 130, the distributed blockchain ledger 131, the nodes 132A-132N, the authentication modules 134A-134N, and the code generator/verification module 137 are stored-program-controlled entities, such as a computer or microprocessor, which performs the method of FIGS. 3-7 and the processes described herein by executing program instructions stored in a computer readable storage medium, such as a memory (i.e., a computer memory, a hard disk, and/or the like). Although the methods described in FIGS. 3-7 are shown in a specific order, one of skill in the art would recognize that the steps in FIGS. 3-7 may be implemented in different orders and/or be implemented in a multi-threaded environment. Moreover, various steps may be omitted or added based on implementation.

The process starts in step 300. The authentication modules 134A-134N receive, in step 302, a request to add a transaction block 202 to the distributed blockchain ledger 131. If a request to add the transaction block 202 to the distributed ledger 131 is not received in step 302, the process of step 302 repeats. Otherwise, if the request to add the transaction block 202 is received in step 302, the authentication modules 134A-134N determine if the one or more authentication credentials 235 in the transaction block 202 are valid in step 304. The authentication modules 134A-134N compares, in step 306, the authentication credential(s) 135 to the authentication credential(s) 235 in the transaction block 202.

If at least a majority of the nodes 132A-132N indicate that the authentication credential(s) 235 are valid in step 306, the transaction block 202 is added to the blockchains 136A-136N in the distributed blockchain ledger 131 in step 310. The process then goes to step 312. Otherwise, if at least a majority of the nodes 132A-132N do not indicate that the authentication credentials 235 are valid, the addition of the transaction block 202 is rejected in step 308. In other words, the transaction block 202 is not added to the blockchains 136A-136N. The process then goes to step 312.

The authentication modules 134A-134N determine, in step 312, if the process is complete. If the process is not complete in step 312, the process goes to step 302. Otherwise, if the process is complete in step 312, the process ends in step 314.

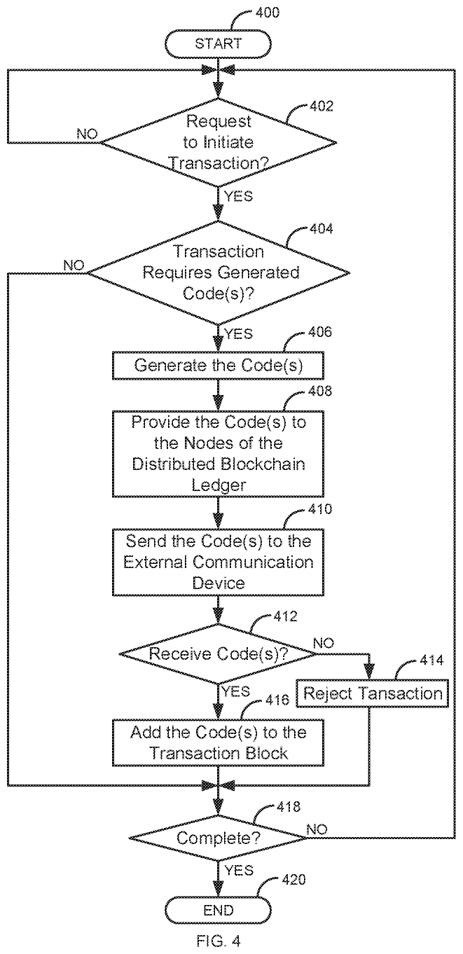

FIG. 4 is a flow diagram of a process for generating codes to validate transaction block 202 additions to a blockchain 136. The process of FIG. 4 applies to transactions where a code (e.g., a random number) is generated and sent to the external communication device 120. For example, the process of FIG. 4 applies to SMS codes, email codes, chat codes, an application approval application (e.g., the external authentication application 124) where a user approves the receipt of a code, and/or the like. The process of FIG. 4 can work where there are multiple authentication factors that require multiple codes. For example, an SMS code may be sent to a first external communication device 120 and a different email code may be sent to a second external communication device 120.

The process starts in step 400. The process waits, in step 402, for a user to request to initiate a transaction. If the user has not made a request to initiate a transaction, the process of step 402 repeats. If the user makes a request to initiate a transaction in step 402, the code generator/verification module 137 determines, in step 404, if the one or more of the authentication factors required for the transaction requires a generated code (e.g., a SMS code). If none of the authentication factors for the transaction requires a generated code in step 404, the process goes to step 418. For example, if the authentication factors are only biometrics, security questions, security ID card(s), and/or a username/password the process goes to step 418.

If one or more of the authentication factors requires a generated code(s) in step 404, the code generator/verification module 137 generates the code(s) in step 406. The generated code(s) are associated with the user (e.g., via an identifier)/authentication factor (e.g., SMS). The code generator/verification module 137 provides the generated code(s) to the authentication modules 134A-134N of the distributed blockchain ledger 131 in step 408. The code generator/verification module 137 sends, in step 410, the generated code(s) to the external communication device(s) 120 (e.g., to the SMS application 121, the email application 122, and/or the external authentication application 124). The generated code(s) could also be sent to the communication device 101.

The code generator/verification module 137 waits, in step 412, to receive the code(s) from the external communication device 120 and/or communication device 101. For example, the code generator/verification module 137 may wait for a defined time period to receive the code(s). If the code(s) are not received in the defined period in step 412, the transaction is rejected in step 414 and the process goes to step 418. Otherwise, if the code(s) are received in step 412, the code generator/verification module 137 adds the code(s) to the transaction block 202 in step 416.

The code generator/verification module 137 determines, in step 418, if the process is complete. If the process is not complete in step 418, the process goes back to step 402. Otherwise, if the process is complete in step 418, the process ends in step 420.

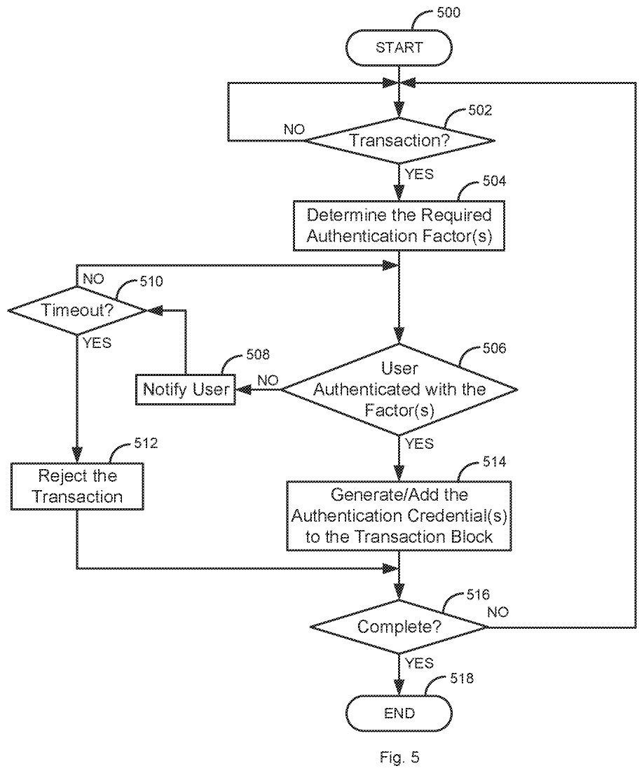

FIG. 5 is a flow diagram of a process for determining that a user has authenticated properly and for generating/adding authentication credentials 235 to a transaction block 202. The process starts in step 500. The code generator/verification module 137 determines, in step 502, if a request it initiate a transaction has been received. If a request to initiate a transaction has not been received in step 502, the process of step 502 repeats. Otherwise, if a request to initiate a transaction has been received in step 502, the code generator/verification module 137 determines, in step 504, the authentication factor(s) required for the user to add the transaction block 202 to the blockchains 136A-136N in the distributed blockchain ledger 131. The authentication factor(s) may be defined based on a block type 205. The authentication factors may apply to every transaction block 202, to several transaction blocks 202, to a login session, and/or the like. How the authentication factors apply to a transaction block 202 being added may be defined by an administrator, may be predefined, and/or the like.

The code generator/verification module 137 determines, in step 506, if the user has authenticated with the necessary authentication factor(s). If the user has not authenticated with the necessary authentication factor(s) in step 506, the user is notified, in step 508, of the authentication factors that are needed to complete the transaction. The code generator/verification module 137 determines if a timeout has occurred in step 510. If a timeout has not occurred in step 510, the process goes back to step 506. Otherwise, if a timeout has occurred in step 510, the transaction is rejected in step 512 and the process goes to step 516.

If the user has authenticated with the necessary authentication factors in step 506, the code generator/verification module 137 generates the authentication credential(s) 235 for the authentication factors (e.g., for biometrics and/or username/password). The code generator/verification module 137 adds, in step 514, the authentication credentials 235 to the transaction block 202.

The code generator/verification module 137 determines, in step 516, if the process is complete. If the process is not complete in step 516, the process goes back to step 502. Otherwise, if the process is complete in step 516, the process ends in step 518.

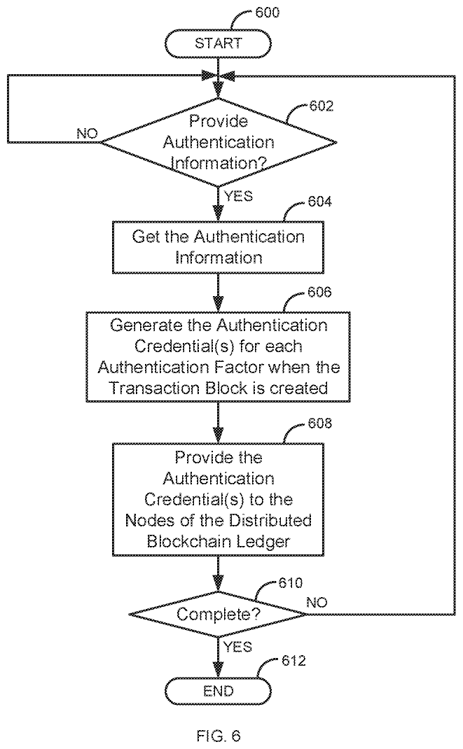

FIG. 6 is a flow diagram of a process for providing authentication credentials 135 to a distributed blockchain ledger 131. The process starts in step 600. The code generator/verification module 137 determines, in step 602, if there is a request to provide authentication information. For example, the user may provide a password, a fingerprint scan, an iris scan, a voiceprint, answers to security questions, and/or the like. If a user is not providing the authentication information in step 602, the process of step 602 repeats.

Otherwise, if the user is providing authentication information in step 602, code generator/verification module 137 gets the authentication information in step 604. The code generator/verification module 137 generates the authentication credential(s) 135 for each authentication factor in step 606. The authentication credentials may be generated based on the new transaction block 202. For example, a hash of the new transaction block 202/timestamp (in the transaction block 202) may be used to generate the authentication credential 135. In this example, the authentication credential 135 for the same user/authentication factor will be different in each transaction block 202. The code generator/verification module 137 provides, in step 608, the authentication credential(s) 135 to the nodes 132A-132N of the distributed blockchain ledger 131.

The code generator/verification module 137 determines, in step 610, if the process is complete. If the process is not complete in step 610, the process goes back to step 602. Otherwise, if the process is complete in step 610, the process ends in step 612.

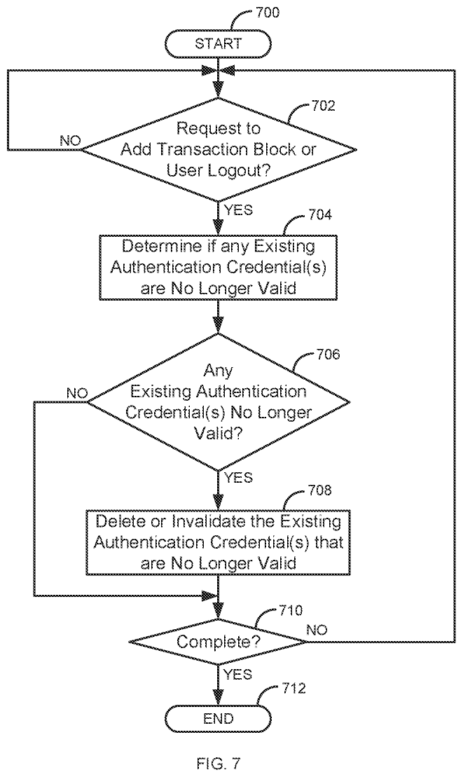

FIG. 7 is a flow diagram of a process for managing authentication credentials 135 in a distributed ledger 131. The process starts in step 700. The authentication modules 134A-134N determines, in step 702, if a request to add a transaction block 202 has been received or if the user has logged out. If a request to add a transaction block 202 is received or the user has not logged out in step 702, the process of step 702 repeats.

Otherwise, if a request to add a transaction block 202 has been received or the user has logged out in step 702, the authentication modules 134A-134N determine, in step 704, if any of the existing authentication credentials 135 are no longer valid. For example, if an authentication credential 135 is a one-time use authentication credential, the authentication modules 134A-134N will delete the one-time use authentication credential 135 if it was previously used (or may delete it when used). If the authentication credential 135 is generated based the information in the new transaction block 202, the authentication credential 135 will be deleted if it was previously used (or may delete it when used). If an authentication credential 135 is based on a number of uses, once the number of uses is reached, the authentication credential 135 will be deleted. If the authentication credential 135 is session based, the code generator/verification module 137 will indicate to the authentication modules 134A-134N that the user has logged out. When the indication that the user has logged out is received, the nodes 132A-132N will delete the authentication credential(s) 135.

The nodes 132A-132N may also delete the authentication credentials 135 based on a time period. For example, the authentication credential 135 may have an associated expiration time/date. Once the expiration time is reached, the authentication credential 135 is deleted. Once an authentication credential 135 is deleted, any new transaction blocks 202 will be rejected if the new transaction block 202 has an authentication credential 235 that is the same as the deleted authentication credential.

If all the existing authentication credential(s) 135 are valid in step 706, the process goes to step 710. Otherwise, if any of the existing authentication credential(s) are no longer valid in step 706, the authentication modules 134A-134N delete or invalidate all the existing authentication credential(s) 135 that are no longer valid in step 708.

The authentication modules 134A-134N determines, in step 710, if the process is complete. If the process is not complete in step 710, the process goes back to step 702. Otherwise, if the process is complete in step 710, the process ends in step 712.

While the processes described herein in discuss where all the transaction blocks 202A-202N have been added based on the authentication credentials 135/235, the process may work with an existing blockchain 136 that initially did not use the authentication credential 135/235 that are stored in the transaction blocks 202. For example, the processes described herein may be applied to an existing blockchain, such as, Bitcoin™ where new transaction blocks 202 can be added that include the authentication credentials 235.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits several known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that can supply and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

Several variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to standards and protocols, the disclosure is not limited to such standards and protocols. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether such alternate, interchangeable and/or equivalent structures, functions, ranges, or steps are disclosed herein, and without intending to publicly dedicate any patentable subject matter.

What is claimed is:

1. A system comprising:
one or more microprocessors; and
a computer readable medium, coupled with the one or more microprocessors and comprising microprocessor readable and executable instructions that, when executed by the one or more microprocessors, cause the one or more microprocessors to:
receive, by a plurality of nodes that are part of a distributed blockchain ledger, a request to add a first transaction block to a plurality of blockchains in the distributed blockchain ledger, wherein the first transaction block comprises one or more transaction block authentication credentials;
determine, by the plurality of nodes that are part of the distributed blockchain ledger, if the one or more transaction block authentication credentials are valid;
receive, an indication from at least a majority of the plurality of nodes that are part of the distributed blockchain ledger that the one or more transaction block authentication credentials are valid; and
in response to receiving the indication from the at least a majority of the plurality of nodes that are part of the distributed blockchain ledger that the one or more transaction block authentication credentials are valid, add, by the plurality of nodes that are part of the distributed blockchain ledger, the first transaction block to the plurality of blockchains in the distributed blockchain ledger.

2. The system of claim 1, wherein the microprocessor readable and executable instructions further cause the one or more microprocessors to:
generate a first authentication credential, wherein the first authentication credential is a code; and
provide the first generated authentication credential to the plurality of nodes that are part of the distributed blockchain ledger, wherein determining if the one or more transaction block authentication credentials are valid comprises: comparing, by the plurality of nodes that are part of the distributed blockchain ledger, the first generated authentication credential to a first transaction block authentication credential of the one or more transaction block authentication credentials.

3. The system of claim 2, wherein a plurality of generated authentication credentials are provided to the plurality of nodes and wherein the plurality of generated authentication credentials are based on at least one of: a plurality of users, a plurality of time periods, a plurality of login sessions, a plurality of authentication factors, and a plurality of single use credentials.

4. The system of claim 3, wherein the plurality of generated authentication credentials are based on the plurality of users and wherein the plurality of nodes uses a user identifier in the first transaction block to identify the first generated authentication credential from the plurality of generated authentication credentials.

5. The system of claim 2, wherein the first generated authentication credential is one of a Short Message Service (SMS) code, an email code, and a chat code.

6. The system of claim 5, wherein the first generated authentication credential is a random number that is sent to an external communication device of a user to authenticate the user.

7. The system of claim 1, wherein a first transaction block authentication credential of the one or more transaction block authentication credentials is generated based on a username and wherein a second transaction block authentication credential of the one or more transaction block authentication credentials is one of a Short Message Service (SMS) code, an email code, and a chat code.

8. The system of claim 1, wherein the first transaction block has a first block type that requires a different number of transaction block authentication credentials than a second transaction block in the plurality of blockchains in the distributed blockchain ledger.

9. The system of claim 1, wherein the one or more transaction block authentication credentials comprise a plurality of transaction block authentication credentials and wherein the plurality of transaction block authentication credentials are associated with a plurality of different users.

10. The system of claim 1, wherein the microprocessor readable and executable instructions further cause the one or more microprocessors to:
provide a first generated authentication credential to the plurality of nodes that are part of the distributed blockchain ledger,
determine, by the plurality of nodes that are part of the distributed blockchain ledger that the first generated authentication credential has expired; and
in response to determining that the first generated authentication credential has expired, delete, or invalidate, by the plurality of nodes that are part of the distributed blockchain ledger, the first generated authentication credential.

11. A method comprising:
receiving, by a plurality of nodes that are part of a distributed blockchain ledger, a request to add a first transaction block to a plurality of blockchains in the distributed blockchain ledger, wherein the first transaction block comprises one or more transaction block authentication credentials;
determining, by the plurality of nodes that are part of the distributed blockchain ledger, if the one or more transaction block authentication credentials are valid;
receiving, an indication from at least a majority of the plurality of nodes that are part of the distributed blockchain ledger that the one or more transaction block authentication credentials are valid; and
in response to receiving the indication from the at least a majority of the plurality of nodes that are part of the distributed blockchain ledger that the one or more transaction block authentication credentials are valid, adding, by the plurality of nodes that are part of the distributed blockchain ledger, the first transaction block to the plurality of blockchains in the distributed blockchain ledger.

12. The method of claim 11, further comprising:
generating a first authentication credential, wherein the first authentication credential is a code; and
providing the first generated authentication credential to the plurality of nodes that are part of the distributed blockchain ledger, wherein determining if the one or more transaction block authentication credentials are valid comprises: comparing, by the plurality of nodes that are part of the distributed blockchain ledger, the first generated authentication credential to a first transaction block authentication credential of the one or more transaction block authentication credentials.

13. The method of claim 12, wherein a plurality of generated authentication credentials are provided to the plurality of nodes and wherein the plurality of generated authentication credentials are based on at least one of: a plurality of users, a plurality of time periods, a plurality of login sessions, a plurality of authentication factors, and a plurality of single use credentials.

14. The method of claim 12, wherein the first generated authentication credential is a generated based on a biometric of a user.

15. The method of claim 12, wherein the first generated authentication credential is one of a Short Message Service (SMS) code, an email code, and a chat code.

16. The method of claim 11, wherein a first transaction block authentication credential of the one or more transaction block authentication credentials is generated based on a username and wherein a second transaction block authentication credential of the one or more transaction block authentication credentials is one of a Short Message Service (SMS) code, an email code, and a chat code.

17. The method of claim 11, wherein the first transaction block has a first block type that requires a different number of transaction block authentication credentials than a second transaction block in the plurality of blockchains in the distributed blockchain ledger.

18. The method of claim 11, wherein the one or more transaction block authentication credentials comprise a plurality of transaction block authentication credentials and wherein the plurality of transaction block authentication credentials are associated with a plurality of different users.

19. The method of claim 11, further comprising:
providing a first generated authentication credential to the plurality of nodes that are part of the distributed blockchain ledger,
determining, by the plurality of nodes that are part of the distributed blockchain ledger that the first generated authentication credential has expired; and
in response to determining that the first generated authentication credential has expired, deleting or invalidating, by the plurality of nodes that are part of the distributed blockchain ledger, the first generated authentication credential.

20. A non-transient computer readable medium having stored thereon instructions that cause one or more microprocessors to execute a method, the method comprising instructions to:
receive, by a plurality of nodes that are part of a distributed blockchain ledger, a request to add a first transaction block to a plurality of blockchains in the distributed blockchain ledger, wherein the first transaction block comprises one or more transaction block authentication credentials;
determine, by the plurality of nodes that are part of the distributed blockchain ledger, if the one or more transaction block authentication credentials are valid;
receive, an indication from at least a majority of the plurality of nodes that are part of the distributed blockchain ledger that the one or more transaction block authentication credentials are valid; and
in response to receiving the indication from the at least a majority of the plurality of nodes that are part of the distributed blockchain ledger that the one or more transaction block authentication credentials are valid, add, by the plurality of nodes that are part of the distributed blockchain ledger, the first transaction block to the plurality of blockchains in the distributed blockchain ledger.
